(19) United States
(12) Patent Application Publication
(10) Pub. No.: US 2025/0117772 A1
(43) Pub. Date: Apr. 10, 2025

(54) Electronic Devices and Corresponding Methods for Presenting Offered Payment Notifications on a User Interface

(71) Applicant: Motorola Mobility LLC, Chicago, IL (US)

(72) Inventors: Amit Kumar Agrawal, Bangalore (IN); Krishnan Raghavan, Bangalore (IN); Hariprasad Shanbhogue Alampady, Bangalore (IN)

(21) Appl. No.: 18/376,757

(22) Filed: Oct. 4, 2023

(51) Int. Cl. G06Q 20/32; G06Q 20/38

(52) U.S. Cl. CPC G06Q 20/325; G06Q 20/389

(57) ABSTRACT

An electronic device includes a user interface, a communication device, and one or more processors operable with the user interface and communication device. The one or more processors are configured to determine a prospective financial transaction with a merchant requiring an on-site payment, retrieve, using the communication device, one or more payment modes accepted by the merchant using electronic signals across a network, and cause the user interface to present an offered payment mode notification identifying the one or more payment modes accepted by the merchant prior to the prospective financial transaction.

### BACKGROUND

### Technical Field

This disclosure relates generally to electronic devices, and more particularly to electronic devices having user interfaces.

### Background Art

Portable electronic devices, such as smartphones and tablet computers, are now the primary electronic tools with which people communicate, engage in commerce, maintain calendars and itineraries, monitor health, capture images and video, and surf the Internet. In many instances, a person is more likely to carry a smartphone than a watch or wallet. Indeed, with the advent of personal finance, banking, and shopping applications many people can transact personal business solely using a smartphone and without the need for cash or a physical credit card.

As these devices begin to use more and more financial information, issues can arise when the personal finance, banking, and shopping applications operable in a device are incompatible with merchant systems. It would be advantageous to have improved devices and systems to prevent such issues from occurring.

### BRIEF DESCRIPTION OF THE DRAWINGS

The accompanying figures, where like reference numerals refer to identical or functionally similar elements throughout the separate views and which together with the detailed description below are incorporated in and from part of the specification, serve to further illustrate various embodiments and to explain various principles and advantages all in accordance with the present disclosure.

FIG. 1 illustrates one or more method steps in accordance with one or more embodiments of the disclosure.

FIG. 2 illustrates one explanatory electronic device in accordance with one or more embodiments of the disclosure.

FIG. 3 illustrates one or more method steps in accordance with one or more embodiments of the disclosure.

FIG. 4 illustrates one or more method steps in accordance with one or more embodiments of the disclosure.

FIG. 5 illustrates one or more method steps in accordance with one or more embodiments of the disclosure.

FIG. 6 illustrates one or more method steps in accordance with one or more embodiments of the disclosure.

FIG. 7 illustrates one or more method steps in accordance with one or more embodiments of the disclosure.

FIG. 8 illustrates one or more embodiments of the disclosure.

FIG. 9 illustrates a prior art method where things go incredibly awry in a gym.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to detecting, with one or more processors of an electronic device, a prospective financial transaction with a merchant, retrieving, with a communication device of the electronic device, one or more processors payment modes offered by the merchant from a remote electronic device across a network, and presenting, by the one or more processors on a user interface of the electronic device, the one or more payment modes offered by the merchant in an offered payment mode notification. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of detecting, by one or more processors, an expected future financial transaction with a merchant requiring on-site payment, retrieving with a communication device of the electronic device, a preferred payment mode accepted by the merchant offering one or more of a maximum discount and/or a maximum loyalty program reward in addition to one or more processors payment modes accepted by the merchant from a remote electronic device across a network, and presenting, by the one or more processors on a user interface of the electronic device, an offered payment mode notification identifying the preferred payment mode and the one or more of the maximum discount and/or the maximum loyalty program reward prior to the expected future financial transaction occurring as described herein. The non-processor circuits may include, but are not limited to, a radio receiver, a radio transmitter, signal drivers, clock circuits, power source circuits, and user input devices. As such, these functions may be interpreted as steps of a method to perform receiving a financial transaction initiation communication comprising an electronic device identifier from which a financial transaction initiation request was received, querying a functional database to determine whether the electronic device identifier is associated with fraud, and, if so, presenting a prompt warning of fraudulent activity.

Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent. The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

Embodiments of the disclosure provide methods, electronic devices, and systems that alert users to payment modes offered by a merchant in an offered payment mode notification presented on a user interface of an electronic device. In one or more embodiments, the offered payment mode notification is presented before an expected future financial transaction from information retrieved from a remote electronic device across a network. In one or more embodiments, one or more processors detect a prospective financial transaction with a merchant and then, in response, retrieve one or more payment modes offered by the merchant from a remote electronic device across a network. The one or more processors then present the one or more processors payment modes offered by the merchant in an offered payment mode notification presented on a user interface of the electronic device.

Advantageously, embodiments of the disclosure prevent embarrassment that can occur when a person has a smartphone with a wallet that a merchant does not accept, the loss of time that occurs when a person is confused by the various payment modes offered by a particular merchant, and the loss of benefits that may result when a person chooses a payment mode that is not associated with a maximum discount and/or maximum loyalty program reward offered by a merchant. Embodiments of the disclosure do this by predicting payments a user is likely to make at a particular merchant, gathering supported payment modes offered by the merchant, and facilitating a list of optimal payment modes as a function of supported and unsupported payment modes of the merchant as well as recommendations in view of offers, loyalty points, and so forth. In one or more embodiments, an offered payment mode notification is presented at particular times of day, examples of which include the start of the day or when a user leaves their “home” location defined by their place of residence.

Embodiments of the disclosure contemplate that many modern electronic devices include both financial applications and shopping applications. Illustrating by example, Motorola Mobility has launched a banking application called DIMO.sup.TM in Brazil. This, as well as other, banking applications are redefining the way that banking occurs. Rather than having to go to a bank to physically talk to a teller during business hours to complete a financial transaction, banking applications offer “24-7” banking with instantaneous transfers of money. Banking can be done exclusively using a smartphone. Even automated teller machine (ATM) withdrawals can be made using only a smartphone.

The advent of applications such as DIMO.sup.TM are leading to users simply ceasing to carry paper currency or coins. Moreover, applications like DIMO.sup.TM have caused people to stop carrying physical credit and debit cards as well since the credit and debit card account information can simply be loaded into a smartphone, with near-field and other communication devices allowing direct transactions of money electronically.

Embodiments of the disclosure also contemplate that users generally have several payment options when visiting a merchant. While this is convenient, it can present problems.

Illustrating by example, not all merchants accept all payment modes. This can create embarrassing situations for users where they consume a good or service but are unable to pay for the good or service using the payment modes they possess.

Similarly, when there are too many payment modes available, some users can get confused regarding which payment mode is the optimal one to choose. Some may not be supported, which can result with a back-and-fort negotiation between the consumer and merchant, which results in a loss of time. Other payment modes may result in the assessment of additional fees at specific places, which are unknown by the user. What's more, since some payment modes are not accepted, or since some users choose the wrong payment modes, users may lose out on “payment specific benefits” like discounts, loyalty points, cash back offers, and so forth.

Embodiments of the disclosure provide a solution to this madness by providing contextually relevant alerts that let a person know not only which payment modes are accepted by a merchant, but which payment modes are most optimal in that they are not only accepted by the merchant but also offer maximum discount and/or maximum loyalty program rewards. Advantageously, embodiments of the disclosure help to save people time, eliminate embarrassing situations, and result in greater financial rewards.

In one or more embodiments, an electronic device comprises a user interface, a communication device, and one or more processors operable with eth user interface and the communication device. In one or more embodiments, the one or more processors are configured to determine from a prospective financial transaction with a merchant requiring an on-site payment and, when this occurs, retrieve, using the communication device, one or more payment modes accepted by the merchant using electronic signals across a network. In one or more embodiments, the one or more processors then cause the user interface to present an offered payment mode notification identifying the one or more processors payment modes accepted by the merchant prior to the prospective financial transaction.

Advantageously, embodiments of the disclosure prevent not only embarrassment but also the loss of time and benefits when engaging in a financial transaction. Consider some examples:

Imagine Vidhya has a last minute purchase to make for an event coming early the next morning. Imagine that Vidhya starts her meticulous search in a store a couple of miles away. By the times she decides what to buy, it has become quite late.

As the clerk prints the bill, Vidhya takes out her smartphone. Since it has a digital wallet, she plans to make payment using the smartphone. Unfortunately, the clerk politely refuses, explaining that this particular merchant does not accept digital wallet payments. Frustrated, Vidhya takes out her credit card, but the store does not accept that brand of card either. Downtrodden, Vidhya leaves the store without her purchase because she does not have enough cash on hand to complete the purchase. The prospect of not having her last minute purchase for her upcoming event become very real.

Advantageously, embodiments of the disclosure prevent such situations from happening. In one or more embodiments, a method in an electronic device comprises detecting, by one or more processors, an expected future financial transaction with a merchant requiring an on-site payment. In one or more embodiments, a communication device then retrieves a preferred payment mode accepted by the merchant offering one or more of a maximum discount and/or a maximum loyalty program reward in addition to one or more payment modes accepted by the merchant. In one or more embodiments. The communication device retrieves this information from a remote electronic device across a network.

In one or more embodiments, the one or more processors then present, on a user interface of the electronic device, an offered payment mode notification identifying the preferred payment mode and the one or more of the maximum discount and/or the maximum loyalty program reward prior to the expected future financial transaction occurring.

In one or more embodiments, the remote electronic device is operated by a payment method purveyor or a payment mode processor and the maximum discount and/or the maximum loyalty program reward are published only by the payment method purveyor or the payment mode processor. In one or more embodiments, the preferred payment mode defines a recommended mode presented in addition to the one or more processors payment modes accepted by the merchant.

Advantageously, embodiments of the disclosure predict payment methods accepted by businesses, gather supported payment modes accepted by the businesses, and facilitate a list of such payment methods prior to an expected future financial transaction occurring. This saves time, avoids embarrassment, and ensures that a person obtains the maximum discount or maximum loyalty program reward when making a purchase. Other advantages will be described below. Still others will be obvious to those of ordinary skill in the art having the benefit of this disclosure.

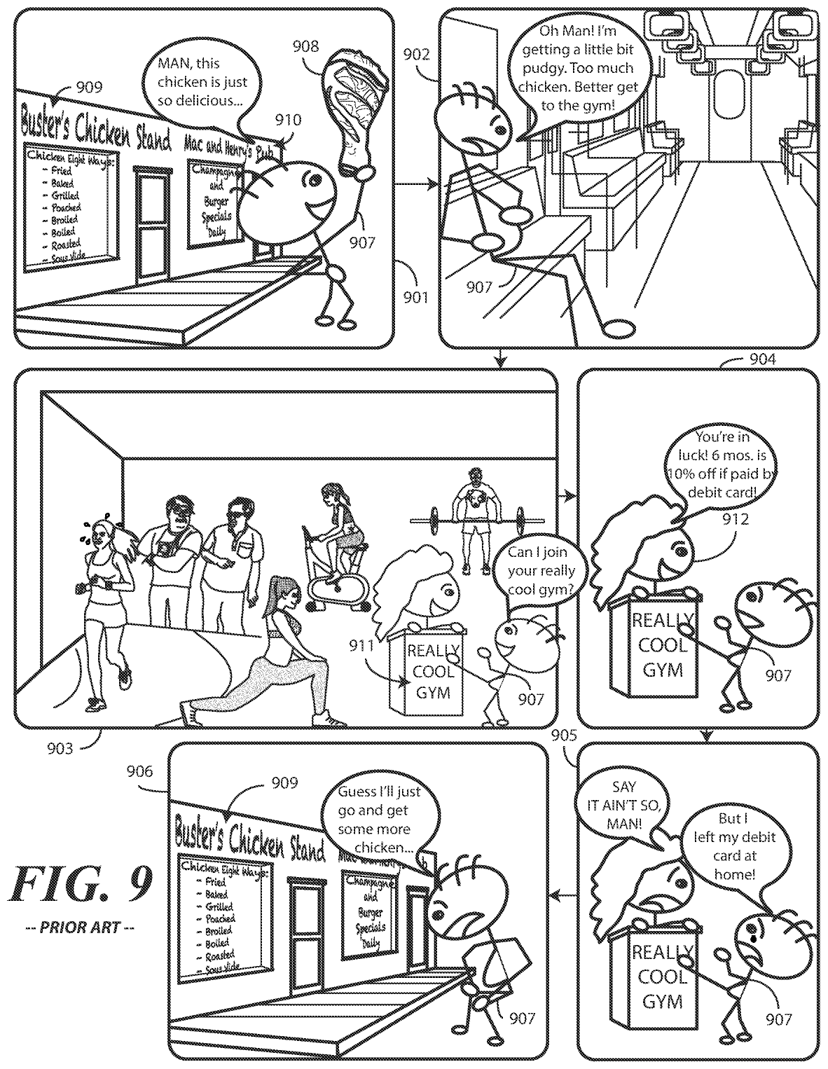

Turning first to FIG. 9, illustrated therein are one or more method steps indicating how a person whose fragile motivation is already on the wane can completely lose the same. Beginning at step 901, the ever so svelte Krish 907 has just stopped by the world famous Buster's Chicken Stand 909 for some of its exceptionally good chicken 908, which is served eight different ways. Buster's Chicken Stand 909 is located next to the equally famous Mac and Henry's Pub 910, where Champagne and burgers are served daily as a local favorite specialty.

Krish 907 has been doing this for some time, and it has become not just a habit, but more of a daily ritual. Unfortunately, devouring Buster's delicious chicken 908 is not without its unintended consequences. As shown at step 902, when Krish 907 is on the train ride home, he notices he's a little thicker than normal. Not being one to sit on his laurels (or extra pounds), Krish 907 immediately makes a New Year's resolution to join a gym.

At step 903, on January 1^{st}, Krish 907 heads to the nearest “Really Cool Gym” 911 and asks to join. As shown at step 904, the staff 912 is really excited, and lets Krish 907 know that there is a ten percent discount on the half yearly subscription if Krish pays with a debit card. As luck would have it, As shown at step 905 Krish 907 is not carrying any of his cards. He has a banking account in an electronic wallet in his smartphone and cash but has no debit card today.

Krish 907 does not want to forego the discount, as it is significant. With his already fragile motivation on the wane, Krish 907 heads back to Buster's Chicken Stand 909 for more chicken and self-contemplation about how he could have avoided this frustrating situation if he'd only known about the offer earlier.

Sadly, situations such as Krish's are all too common. People suffer from embarrassment because not all merchants accept all payment methods. This creates embarrassing situations for users sometimes where they end up using a service but are unable to pay with any of the payment methods they possess. When there are too many payment modes, users can get confused about which payment method to use. Some may not be supported, resulting in back-and-forth. Others may have additional fees at specific places, and so forth, which can result in time wastage for the business, the user, and other customers waiting to pay. What's more, due to specific payment methods not being accepted or the users choosing a wrong payment method (due to lack of awareness, for example), users may lose out on “payment method specific benefits” like discounts, loyalty points, cashbacks, and so forth.

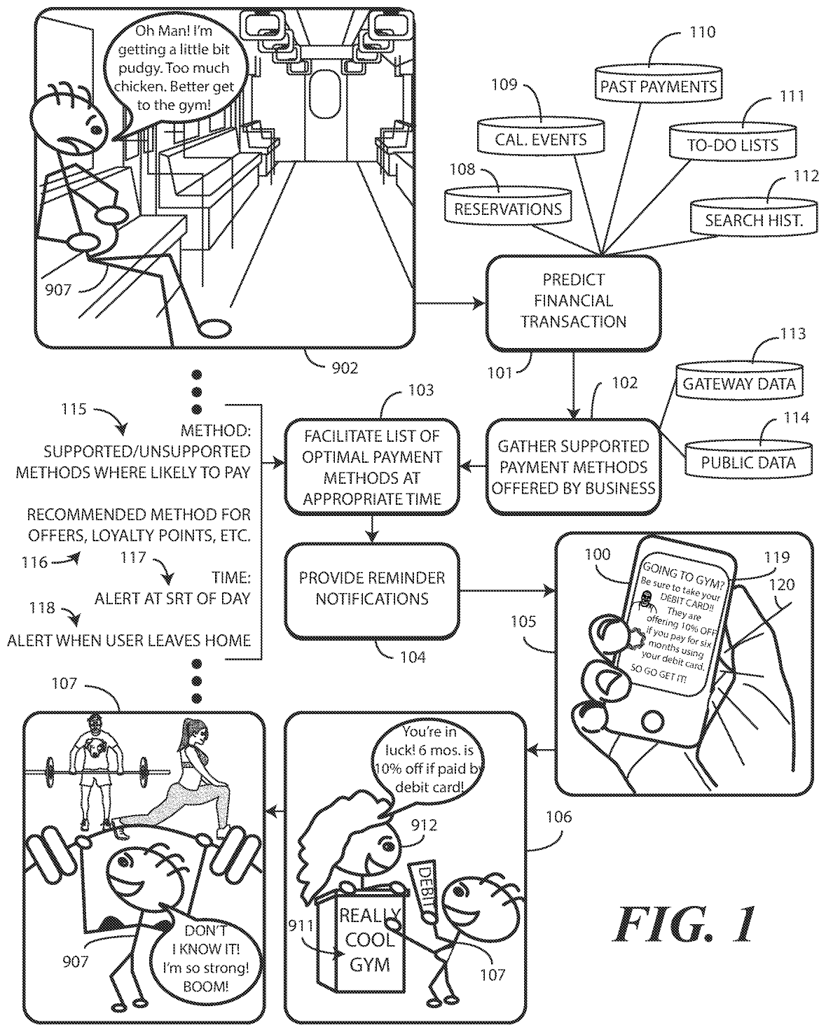

Fortunately, embodiments of the disclosure provide a solution to these problems. In one or more embodiments, a method in an electronic device comprises detecting, with one or more processors of the electronic device, a prospective financial transaction with a merchant. A communication device then retrieves one or more payment modes offered by the merchant from a remote electronic device across a network. The one or more processors then present, on a user interface of the electronic device, the one or more payment modes offered by the merchant in an offered payment mode notification. Turning now to FIG. 1, illustrated therein are one or more method steps depicting how the dreadful situation illustrated in FIG. 9 can be avoided using embodiments of the disclosure.

FIG. 1 begins with step 902 of FIG. 9. At step 902, Krish 907 is wondering exactly what Buster puts in that wonderful chicken, as he notices that eating it has caused a bit of weight gain. Thus, he sets his now infamous resolution to join a gym in the new year.

At step 101, one or more processors of his electronic device 100 (shown as a smartphone at step 105) predict a prospective financial transaction with a merchant. This can be done in a variety of ways.

Illustrating by example, one or more processors of the electronic device 100 can query a database of reservations 108 made using the electronic device 100 with a merchant, examples of which include the gym, a restaurant, a hospital, or a recreational service provider. In this illustrative embodiment, Krish 907 set a reminder in a database of calendar events 109 used by a calendaring application operating on the one or more processors of the electronic device 100. Accordingly, the one or more processors have queried this database of calendar events 109 to detect the prospective financial transaction with the Really Cool Gym 911.

In other embodiments, the one or more processors of the electronic device 100 can query a database of past financial transactions 110 to detect the prospective financial transaction with the merchant. Embodiments of the disclosure contemplate that many electronic wallet programs will maintain such a database of past financial transactions 110, including those associated with a particular time the financial transaction occurred or a particular location in which the financial transaction transpired. In one or more embodiments, the one or more processors of the electronic device 100 detect the prospective financial transaction with the merchant by querying this database of past financial transactions. This querying operation can be triggered, for example, when a particular time that a past financial transaction occurred is occurring during the day or when a location detector of the electronic device 100 determines that the electronic device 100 is at a location where a past financial transaction occurred. Other techniques for triggering the query of this database or the others will be obvious to those of ordinary skill in the art having the benefit of this disclosure.

In still another embodiment, the one or more processors of the electronic device 100 can detect the prospective financial transaction with the merchant by querying an electronic to-do list 111 stored in a memory of the electronic device 100. Illustrating by example, rather than setting a reminder in the calendaring application, Krish 907 may have created an electronic to-do entry in an electronic to-do list 111 stored in a memory of the electronic device 100 that says, “Join a Gym and Cut Back on that Delicious Buster's Chicken.” Accordingly, the one or more processors of the electronic device 100 may detect the prospective financial transaction with the Really Cool Gym 911 by retrieving this electronic to-do entry from the electronic to-do list 111.

In still other embodiments, the one or more processors can detect the prospective financial transaction with a merchant by examining a past search history 112 of an Internet browser application. If Krish 907 had been trying to decide between the Really Cool Gym 911 and its nearest competitor, Slightly Cool Gym, he may have searched for each using an Internet browser application. After spending more time on the Really Cool Gym website than that of the Slightly Cool Gym, the one or more processors of the electronic device 100 may have detected a prospective financial transaction with the Really Cool Gym 911. These examples of how one or more processors of an electronic device 100 can detect a prospective financial transaction with a merchant. Others will be described below. Still others will be obvious to those of ordinary skill in the art having the benefit of this disclosure.

At step 102, the one or more processors of the electronic device 100 gather supported payment modes offered by a merchant by fetching and analyzing data from a remote electronic device over a network. Said differently, in one or more embodiments step 102 comprises retrieving, with a communication device of the electronic device 100, one or more payment modes offered by the merchant from a remote electronic device across a network.

In one or more embodiments, this data comprises data 113 available with the payment processor or payment gateway that a connecting banking server uses to process financial transactions with the merchant. In other embodiments, this data comprises data 114 that is publicly available. Illustrating by example, the data 114 that is publicly available may be obtained by accessing a website operated by the merchant and so forth.

At step 103, the one or more processors of the electronic device 100 facilitate a list of optimal payment modes accepted by the merchant. In one or more embodiments, this is performed by presenting the one or more payment modes offered by the merchant in an offered payment mode notification. In one or more embodiments, the one or more processors surface an optimal payment method as a preferred payment mode in the offered payment mode notification.

In one or more embodiments, the optimal payment mode is determined as a factor of supported and unsupported payment modes 115 at the merchant that the Krish 907 is likely to engage in a financial transaction. In other embodiments, the optimal payment mode is determined as a function of offers, loyalty points, or loyalty program rewards 116. Other techniques for prioritizing the optimal payment mode will be obvious to those of ordinary skill in the art having the benefit of this disclosure.

Embodiments of the disclosure can also be configured to present the offered payment mode notification at the proper time as well. Illustrating by example, in one or more embodiments the offered payment mode notification is presented at a particular time of day 117, such as the waking time of Krish 907 as determined from an alarm clock application operating on the one or more processors or from a first scheduled event in a calendaring application operating on the one or more processors of the electronic device 100. In other embodiments, the offered payment mode notification can be presented on the user interface when a location detector of the electronic device 100 determines that Krish 907 is leaving a particular location 118, one example of which is his residence. Other examples of times when the offered payment mode notification can be presented will be obvious to those of ordinary skill in the art having the benefit of this disclosure.

At step 104, the one or more processors present, on a user interface of the electronic device 100, the one or more payment modes offered by the merchant. In one or more embodiments, this occurs via the presentation of an offered payment mode notification 119, one example of which is shown at step 105. In this illustrative embodiment, the offered payment mode notification 119 asks Krish 907, “Going to Gym?” The offered payment mode notification 119 then includes a reminder to take a debit card, as the Really Cool Gym 911 is offering at ten percent discount if he pays for six months using a debit card. To show that the offered payment mode notification 119 is urgent and should not be ignored, the offered payment mode notification 119 includes a reminder to “go get it” for emphasis.

In one or more embodiments, this offered payment mode notification 119 is presented at a predetermined time during the day. In this illustrative embodiment, the predetermined time during the day occurs when a location detector detects Krish 907, an authorized user of the electronic device 100, exiting his dwelling. In this illustrative embodiment, the offered payment mode notification 119 is presented when an audio output device of the electronic device 100 delivers an audible alert 120 concurrently therewith.

At step 106, Krish 907 again heads to the nearest “Really Cool Gym” 911 and asks to join. Once again, the staff 912 is really excited, and lets Krish 907 know that there is a ten percent discount on the half yearly subscription if Krish pays with a debit card. Since Krish's smartphone is configured in accordance with embodiments of the disclosure, Krish 907 is indeed carrying his debit card. Accordingly, he does not need to worry about his fragile motivation waning. Instead, he promptly joins the Really Cool Gym 911 and earns the ten percent discount. At step 107, he is elated that his smartphone predicted this financial transaction with the Really Cool Gym 911 so he could start working out, lose the chicken fat, and pump some really huge muscles.

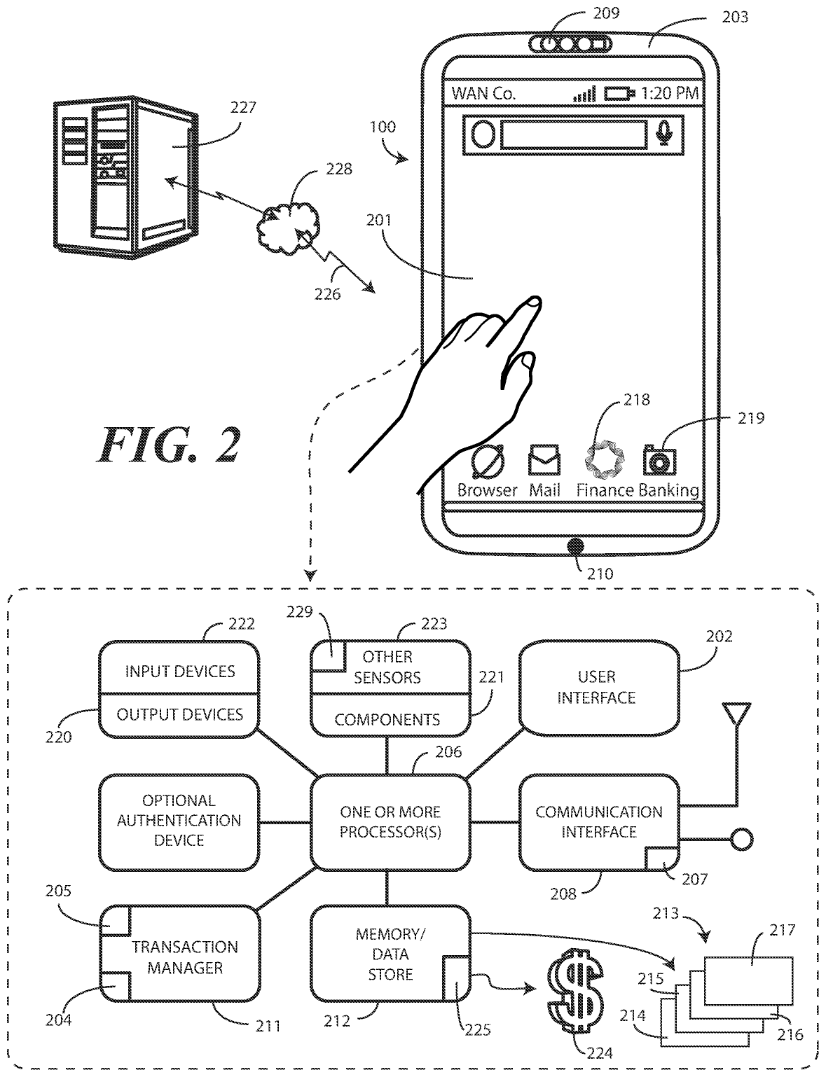

Turning now to FIG. 2, illustrated therein is one electronic device 100 configured in accordance with one or more embodiments of the disclosure. The electronic device 100 of this illustrative embodiment includes a user interface 202. In one or more embodiments, the user interface 202 comprises a display 201, which may optionally be touch-sensitive. The display 201 can serve as a primary user interface 202 of the electronic device 100.

Where the display 201 is touch sensitive, users can deliver user input to the display 201 by delivering touch input from a finger, stylus, or other objects disposed proximately with the display. In one embodiment, the display 201 is configured as an active-matrix organic light emitting diode (AMOLED) display. However, it should be noted that other types of displays, including liquid crystal displays, would be obvious to those of ordinary skill in the art having the benefit of this disclosure.

The explanatory electronic device 100 of FIG. 2 includes a housing 203. Features can be incorporated into the housing 203. Examples of features that can be included along the housing 203 include an imager 209, shown as a camera in FIG. 2, or an optional speaker port. A user interface component 210, which may be a button or touch sensitive surface, can also be disposed along the housing 203.

A block diagram schematic of the electronic device 100 is also shown in FIG. 2. In one embodiment, the electronic device 100 includes one or more processors 206. In one embodiment, the one or more processors 206 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more Application Specific Integrated Circuits (ASICs), programmable logic, or other type of processing device. The application processor and the auxiliary processor(s) can be operable with the various components of the electronic device 100. Each of the application processor and the auxiliary processor(s) can be configured to process and execute executable software code to perform the various functions of the electronic device 100. A storage device, such as memory 212, can optionally store the executable software code used by the one or more processors 206 during operation.

In this illustrative embodiment, the electronic device 100 also includes a communication device 208 that can be configured for wired or wireless communication with one or more other devices or networks. The networks can include a wide area network, a local area network, and/or personal area network. The communication device 208 may also utilize wireless technology for communication, such as, but are not limited to, peer-to-peer, or ad hoc communications such as HomeRF, Bluetooth and IEEE 802.11 based communication, or alternatively via other forms of wireless communication such as infrared technology. The communication device 208 can include wireless communication circuitry, one of a receiver, a transmitter, or transceiver, and one or more antennas.

The electronic device 100 can optionally include a near field communication circuit 207 used to exchange data, power, and electrical signals between the electronic device 100 and another electronic device. In one embodiment, the near field communication circuit 207 is operable with a wireless near field communication transceiver, which is a form of radio-frequency device configured to send and receive radio-frequency data to and from the companion electronic device or other near field communication objects.

Where included, the near field communication circuit 207 can have its own near field communication circuit controller in one or more embodiments to wirelessly communicate with companion electronic devices using various near field communication technologies and protocols. The near field communication circuit 207 can include—as an antenna-a communication coil that is configured for near-field communication at a particular communication frequency. The term “near-field” as used herein refers generally to a distance of less than about a meter or so. The communication coil communicates by way of a magnetic field emanating from the communication coil when a current is applied to the coil. A communication oscillator applies a current waveform to the coil. The near field communication circuit controller may further modulate the resulting current to transmit and receive data, power, or other communication signals with companion electronic devices.

In one embodiment, the one or more processors 206 can be responsible for performing the primary functions of the electronic device 100. For example, in one embodiment the one or more processors 206 comprise one or more circuits operable to present presentation information, such as images, text, and video, on the display 201. The executable software code used by the one or more processors 206 can be configured as one or more modules 213 that are operable with the one or more processors 206. Such modules 213 can store instructions, control algorithms, and so forth.

In one embodiment, the one or more processors 206 are responsible for running the operating system environment 214. The operating system environment 214 can include a kernel, one or more drivers, and an application service layer 215, and an application layer 216. The operating system environment 214 can be configured as executable code operating on one or more processors or control circuits of the electronic device 100.

The application service layer 215 can be responsible for executing application service modules. The application service modules may support one or more applications 217 or “apps.” Examples of such applications 217 include a cellular telephone application for making voice telephone calls, a web browsing application configured to allow the user to view webpages on the display 201 of the electronic device 100, an electronic mail application configured to send and receive electronic mail, a photo application configured to organize, manage, and present photographs on the display 201 of the electronic device 100, and a camera application for capturing images with the imager 209. Collectively, these applications constitute an “application suite.”

In one or more embodiments, these applications comprise one or more financial applications 218 and/or banking applications 219 that allow financial transactions to be made using the electronic device 100. Illustrating by example, in one or more embodiments a user can deliver user input to a financial application 218 or a banking application 219 to initiate a financial transaction initiation communication to complete a financial transaction with a merchant. In one or more embodiments, when this occurs the communication device 208 transmits a financial transaction initiation communication 204 generated by a transaction manager 211.

In one or more embodiments, the transaction manager 211 is operable with the one or more processors 206. In some embodiments, the one or more processors 206 can control the transaction manager 211. In other embodiments, the transaction manager 211 can operate independently, delivering information gleaned from detecting multi-modal social cues, emotional states, moods, and other contextual information to the one or more processors 206. The transaction manager 211 can receive data from the various sensors. In one or more embodiments, the one or more processors 206 are configured to perform the operations of the transaction manager 211.

In one or more embodiments, the one or more processors 206 are responsible for managing the applications and all personal information received from the user interface 202 that is to be used by the finance application 218 and/or banking application 219 after the electronic device 100 is authenticated as a secure electronic device and the user identification credentials have triggered a login event. The one or more processors 206 can also be responsible for launching, monitoring and killing the various applications and the various application service modules. In one or more embodiments, the one or more processors 206 are operable to not only kill the applications, but also to expunge any and all personal data, data, files, settings, or other configuration tools when the electronic device 100 is reported stolen to wipe the memory 212 clean of any personal data, preferences, or settings of the person previously using the electronic device 100.

The one or more processors 206 can also be operable with other components 221 and other sensors 223. The other components 221, in one embodiment, include input components 222, which can include acoustic detectors as one or more microphones. The one or more processors 206 may process information from the other components 221 alone or in combination with other data, such as the information stored in the memory 212 or information received from the user interface.

Various sensors 223 can be operable with the one or more processors 206 as well. A first example of a sensor that can be included with the sensors 223 is a touch sensor. The touch sensor can include a capacitive touch sensor, an infrared touch sensor, resistive touch sensors, or another touch-sensitive technology. Capacitive touch-sensitive devices include a plurality of capacitive sensors, e.g., electrodes, which are disposed along a substrate. Each capacitive sensor is configured, in conjunction with associated control circuitry, e.g., the one or more processors 206, to detect an object in close proximity with—or touching—the surface of the display 201 or the housing of an electronic device 100 by establishing electric field lines between pairs of capacitive sensors and then detecting perturbations of those field lines.

Another example of a sensor 223 is a geo-locator that serves as a location detector 229. In one embodiment, location detector 229 is able to determine location data by capturing the location data from a constellation of one or more earth orbiting satellites, or from a network of terrestrial base stations to determine an approximate location. Examples of satellite positioning systems suitable for use with embodiments of the present invention include, among others, the Navigation System with Time and Range (NAVSTAR) Global Positioning Systems (GPS) in the United States of America, the Global Orbiting Navigation System (GLONASS) in Russia, and other similar satellite positioning systems. The satellite positioning systems based location fixes of the location detector autonomously or with assistance from terrestrial base stations, for example those associated with a cellular communication network or other ground based network, or as part of a Differential Global Positioning System (DGPS), as is well known by those having ordinary skill in the art. The location detector 229 may also be able to determine location by locating or triangulating terrestrial base stations of a traditional cellular network, such as a CDMA network or GSM network, or from other local area networks, such as Wi-Fi networks.

One or more motion detectors can be included with the sensors 223 and can be configured as an orientation detector that determines an orientation and/or movement of the electronic device 100 in three-dimensional space. Illustrating by example, the motion detectors can include an accelerometer, gyroscopes, or other device to detect device orientation and/or motion of the electronic device 100. Using an accelerometer as an example, an accelerometer can be included to detect motion of the electronic device. Additionally, the accelerometer can be used to sense some of the gestures of the user, such as one talking with their hands, running, or walking.

The motion detectors can determine the spatial orientation and/or motion of the electronic device 100 in three-dimensional space by, for example, detecting a gravitational direction and acceleration due to applied forces. In addition to, or instead of, an accelerometer, an electronic compass can be included to detect the spatial orientation of the electronic device relative to the earth's magnetic field. Similarly, one or more gyroscopes can be included to detect rotational orientation of the electronic device 100.

A gaze detector can be included with the one or more sensors 223 and can comprise sensors for detecting the user's gaze point. The gaze detector can include an iris scanner. The gaze detector can optionally include sensors for detecting the alignment of a user's head in three-dimensional space. Electronic signals can then be processed for computing the direction of user's gaze in three-dimensional space. The gaze detector can further be configured to detect a gaze cone corresponding to the detected gaze direction, which is a field of view within which the user may easily see without diverting their eyes or head from the detected gaze direction. The gaze detector can be configured to alternately estimate gaze direction by inputting images representing a photograph of a selected area near or around the eyes. It will be clear to those of ordinary skill in the art having the benefit of this disclosure that these techniques are explanatory only, as other modes of detecting gaze direction can be substituted in the gaze detector.

Other components 221 operable with the one or more processors 206 can include output components 220 such as video, audio, and/or mechanical outputs. For example, the output components 220 may include a video output component or auxiliary devices including a cathode ray tube, liquid crystal display, plasma display, incandescent light, fluorescent light, front or rear projection display, and light emitting diode indicator. Other examples of output components 220 include audio output components such as a loudspeaker disposed behind a speaker port or other alarms and/or buzzers and/or a mechanical output component such as vibrating or motion-based mechanisms.

The other components 221 can also include proximity sensors. The proximity sensors fall in to one of two camps: active proximity sensors and “passive” proximity sensors. Either the proximity detector components or the proximity sensor components can be generally used for gesture control and other user interface protocols, some examples of which will be described in more detail below.

Proximity sensor components are sometimes referred to as a “passive IR detectors” due to the fact that the person is the active transmitter. Accordingly, the proximity sensor component requires no transmitter since objects disposed external to the housing deliver emissions that are received by the infrared receiver. As no transmitter is required, each proximity sensor component can operate at a very low power level. Simulations show that a group of infrared signal receivers can operate with a total current drain of just a few microamps.

By contrast, proximity detector components include a signal emitter and a corresponding signal receiver. While each proximity detector component can be any one of various types of proximity sensors, such as but not limited to, capacitive, magnetic, inductive, optical/photoelectric, imager, laser, acoustic/sonic, radar-based, Doppler-based, thermal, and radiation-based proximity sensors, in one or more embodiments the proximity detector components comprise infrared transmitters and receivers.

The other components 221 can optionally include a barometer operable to sense changes in air pressure due to elevation changes or differing pressures of the electronic device 100. Where included, in one embodiment the barometer includes a cantilevered mechanism made from a piezoelectric material and disposed within a chamber. The cantilevered mechanism functions as a pressure sensitive valve, bending as the pressure differential between the chamber and the environment changes. Deflection of the cantilever ceases when the pressure differential between the chamber and the environment is zero. As the cantilevered material is piezoelectric, deflection of the material can be measured with an electrical current.

The other components 221 can also optionally include a light sensor that detects changes in optical intensity, color, light, or shadow in the environment of an electronic device. This can be used to make inferences about context such as weather or colors, walls, fields, and so forth, or other cues. An infrared sensor can be used in conjunction with, or in place of, the light sensor. The infrared sensor can be configured to detect thermal emissions from an environment about the electronic device 100. Similarly, a temperature sensor can be configured to monitor temperature about an electronic device. The other components 221 can also include a flash. The other components 221 can also include a fingerprint sensor or retina scanner.

In one or more embodiments, the one or more processors 206, optionally working in conjunction with the transaction manager 211, is configured to determine a prospective financial transaction with a merchant requiring an on-site payment. Techniques for doing so were described above with reference to FIG. 1. Others will be obvious to those of ordinary skill in the art having the benefit of this disclosure.

In one or more embodiments, when the one or more processors 206 and/or transaction manager 211 determine a prospective financial transaction with a merchant requiring an on-site payment will occur, the one or more processors 206 and/or transaction manager 211 are configured to retrieve, using the communication device 208, one or more payment modes 224 accepted by the merchant using electronic signals 226 from a remote electronic device 227 across a network 228. Thereafter, the one or more processors 206 and/or transaction manager 211 are configured to cause the user interface 202 to present an offered payment mode notification 225 identifying the one or more payment modes 224 accepted by the merchant prior to the prospective financial transaction occurring.

In one or more embodiments, the one or more processors 206 and/or transaction manager 211 are further configured to retrieve, using the communication device and other electronic signals across the network 228, one or more discounts and/or incentive programs 205 offered by the merchant with rewards offered based upon payment mode. Where this occurs, the one or more processors and/or transaction manager 211 are configured to prioritize the payment modes 224 included in the offered payment mode notification 225 in accordance with rewards offered based upon the payment mode. Thus, if paying with a debit card results in more discounts and/or incentive reward points than paying with a credit card, this debit mode of payment would be prioritized in the offered payment mode notification 225.

Where the electronic device 100 is equipped with a location detector 229, in one or more embodiments the one or more processors 206 and/or transaction manager 211 is configured to cause the user interface to present the offered payment mode notification 225 identifying the one or more payment modes 224 accepted by the merchant in response to the location detector 229 detecting the electronic device 100 exciting a dwelling of an authorized user of the electronic device 100. Advantageously, this results in the offered payment mode notification 225 being presented in a timely manner, namely, when an authorized user of the electronic device 100 is leaving their “home” location. Thus, in one or more embodiments a method in the electronic device 100 comprises detecting, by the location detector 229, the electronic device 100 exiting a dwelling of an authorized user of the electronic device 100, with the offered payment mode notification 225 being presented at this predetermined time.

In other embodiments, the one or more processors 206 and/or transaction manager 211 cause the offered payment mode notification 225 to be presented at another predetermined time during the day. Illustrating by example, in other embodiments the one or more processors 206 and/or the transaction manager 211 cause the predetermined time at which the offered payment mode notification 225 is presented to correspond with an alarm of an alarm application of the one or more applications 217. For instance, when an authorized user of the electronic device 100 desires the offered payment mode notification 225 to be presented at the start of the day, the one or more processors 206 and/or transaction manager 211 can present the same when the morning alarm rings. Other predetermined times at which the offered payment mode notification 225 can be presented will be obvious to those of ordinary skill in the art having the benefit of this disclosure.

In one or more embodiments, as was in the illustrative example described above with reference to FIG. 1, the offered payment mode notification 225 reminds the authorized user of the electronic device 100 to be sure to take at least one payment mode of the one or more payment modes accepted by the merchant along with them when going to make the financial transaction corresponding to the prospective financial transaction. In other embodiments, the offered payment mode notification 225 comprises a reminder to electronically add the one or more payment modes accepted by the merchant to an electronic wallet application, such as might be included in the finance application 218 operating on the one or more processors 206. Of course, these various operations can be used alone or in combination. Other operations suitable for inclusion in the abnormal mode of operation will be described below. Still others will be obvious to those of ordinary skill in the art having the benefit of this disclosure.

It is to be understood that FIG. 2 is provided for illustrative purposes only and for illustrating components of one electronic device 100 in accordance with embodiments of the disclosure and is not intended to be a complete schematic diagram of the various components required for an electronic device. Therefore, other electronic devices in accordance with embodiments of the disclosure may include various other components not shown in FIG. 2 or may include a combination of two or more components or a division of a particular component into two or more separate components, and still be within the scope of the present disclosure.

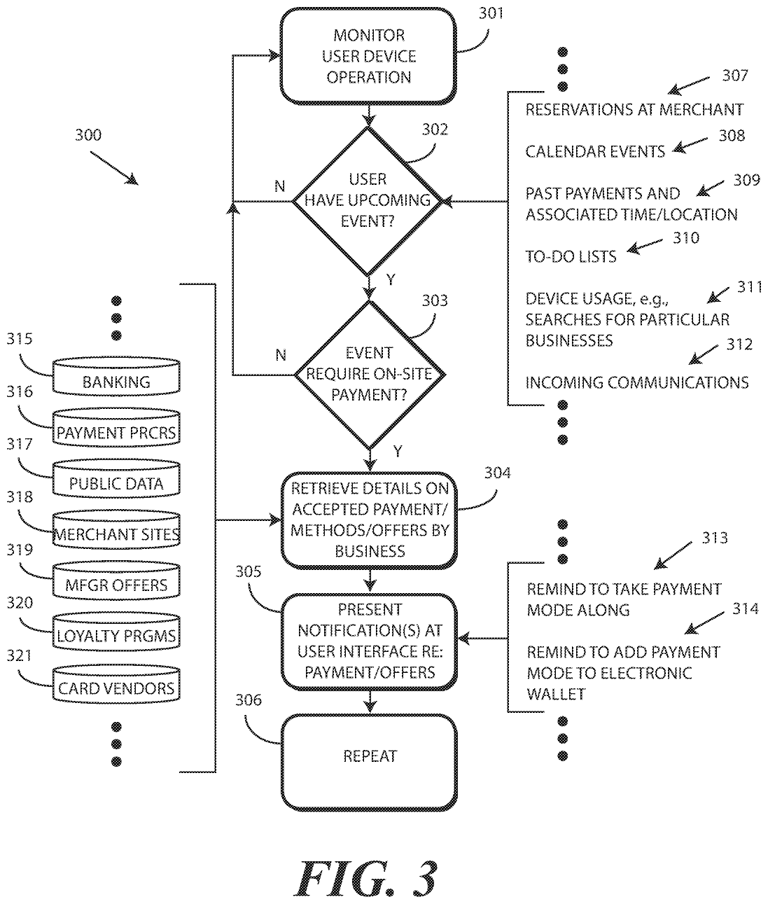

Turning now to FIG. 3, illustrated therein is one explanatory method 300 suitable for execution in an electronic device (100) in accordance with one or more embodiments of the disclosure. The method 300 of FIG. 3 detects a prospective financial transaction with a merchant, retrieves one or more payment modes offered by the merchant from a remote electronic device across a network, and presents the one or more payment modes offered by the merchant in an offered payment mode notification on a user interface of the electronic device. This presentation of the offered payment mode notification can also be accompanied by an audible alert delivered by an audio output device in one or more embodiments.

Beginning at step 301, one or more processors of an electronic device monitor device operation. Decision 302 and decision 303 detect, collectively, am expected future financial transaction with a merchant requiring on-site payment. Decision 302 first determines whether a user of the electronic device has an upcoming event, while decision 303 determines whether the event corresponds to an expected future financial transaction, one example of which is a prospective financial transaction with a merchant, requiring on-site payment at the merchant.

Decision 302 can be made in a variety of ways. Illustrating by example, decision 302 can comprise querying a memory of the electronic device or a remote electronic device in communication with the electronic device, e.g., a “cloud” computing device, to determine whether there are any upcoming reservations 307 with a merchant that have been made electronically using the electronic device. In other embodiments, the detection occurring at decision 302 comprises querying, using one or more processors of the electronic device, a calendaring application 308 to detect a scheduled appointment stored in the calendaring application 308 that identifies the merchant.

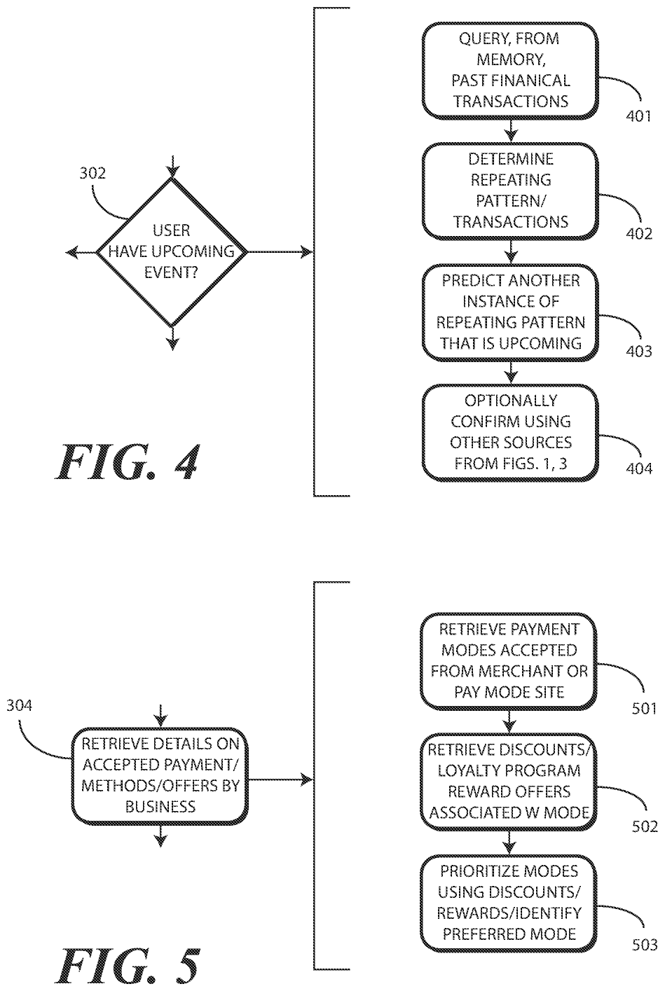

Turning briefly to FIG. 4, in still other embodiments decision 302 comprises querying, at step 401 from a memory of the electronic device or a remote electronic device in communication with the electronic device, past financial transactions 309 made by an authorized user of the electronic device that are stored in the memory. At step 402, decision 302 comprises determining whether a repeating pattern in these financial transactions. From this repeating pattern, step 403 can predict another instance of the repeating pattern, with step 404 using the other sources of FIG. 3 to confirm any prediction of an expected future financial transaction.

Illustrating by example, if our friend from above, Krish, goes to eat at Buster's Chicken Shack every day at 10:15 AM after leaving the Really Cool Gym at 10:00 AM, decision 302 may determine that there is an expected future financial transaction at Buster's Chicken Shack when the repeating pattern is detected and Krish and his electronic device are leaving the Really Cool Gym at 10:00 AM. Accordingly, an affirmative decision made at decision 302 can predict, at step 403, another instance of the repeating pattern as the expected future financial transaction.

Turning now back to FIG. 3, in still other embodiments decision 302 comprises querying, by one or more processors from a memory of the electronic device or a remote electronic device in communication with the electronic device, an electronically stored to-do list 310 to identify one or more to-do list items stored in the memory that reference a merchant. In still other embodiments, decision 302 comprises querying, by one or more processors of the electronic device or a remote electronic device in communication with the electronic device, an Internet search history 311 of a web browsing application stored in the memory to identify a search history entry identifying a merchant.

In still other embodiments, decision 302 can comprise extracting upcoming event information from incoming communications 312. Thus, decision 302 can comprise receiving, with a communication device by one or more processors of an electronic device, an electronic communication 312 identifying both a scheduled appointment and a merchant in one or more embodiments.

For instance, if Krish makes an appointment for a consultation with a trainer at the Really Cool Gym before joining, the trainer may send an email saying, “Your Appointment with Tommy tomorrow at 10:30 AM at the Really Cool Gym has been confirmed.” In one or more embodiments, decision 302 detects an expected future financial transaction by extracting the contextual information from such incoming communications 312.

Presuming an upcoming event is detected, decision 303 determines whether an on-site payment is likely to be required. For many situations, decision 303 can simply identify the merchant with which the upcoming event detected at decision 302 corresponds, as certain types of merchants generally always require on-site payment. Examples of such merchants include grocery stores, barber shops, restaurants, bars, golf courses, and the like. In other embodiments, indicia that an on-site payment is required can be determined by extracting such indicia from the sources from which the upcoming event is detected at decision 302. Illustrating by example, if the upcoming event with Tommy the trainer is detected from incoming communications 312, the email message may also say, “the cost for the consult is $25.” These indicia could be extracted to determine that an on-site payment is required. Other techniques for determining at decision 303 whether the on-site payment is required will be obvious to those of ordinary skill in the art having the benefit of this disclosure.

Step 304, the method 300 retrieves, with a communication device of the electronic device, one or more payment modes offered by the merchant. In one or more embodiments, step 304 comprises retrieving, with a communication device of an electronic device, a preferred payment mode accepted by the merchant offering one or more of a maximum discount or a maximum loyalty program reward in addition to the one or more payment modes accepted by the merchant from a remote electronic device across a network.

In one or more embodiments, the remote electronic device from which the one or more payment modes and/or the preferred payment mode accepted by the merchant offering one or more of the maximum discount or maximum loyalty program reward is operated by a bank 315 associated with a banking application operable on the electronic device. In other embodiments, the remote electronic device is operated by a payment method purveyor 316 or payment mode processor, with the maximum discount and/or the maximum loyalty program reward being published only by the payment mode purveyor or the payment mode processor.

In still other embodiments, the remote electronic device from which the one or more payment modes and/or the preferred payment mode accepted by the merchant offering one or more of the maximum discount or maximum loyalty program reward is retrieved comprises a public server 317, one example of which is a web server operated by, or hosting a website 318 for, a merchant. Manufacturers 319 of goods and sellers of services can offer special offers affecting the one or more payment modes and/or the preferred payment mode accepted by the merchant offering one or more of the maximum discount or maximum loyalty program reward. Loyalty programs 320 can offer incentives informing the one or more payment modes and/or the preferred payment mode accepted by the merchant offering one or more of the maximum discount or maximum loyalty program reward. Similarly, credit card and electronic wallet card vendors 321 can offer special discounts or benefits affecting the one or more payment modes and/or the preferred payment mode accepted by the merchant offering one or more of the maximum discount or maximum loyalty program reward.

Other operations can be performed at step 304 as well. Turning briefly to FIG. 5, illustrated therein are some examples.

In one or more embodiments, as shown at step 501, step 304 can comprise extracting, by one or more processors of the electronic device, data from a merchant website (318) provided by the merchant. At step 502 step 304 can comprise extracting one or more of discounts offered by the merchant using one or more predefined payment modes accepted by the merchant and/or one or more loyalty programs offering one or more rewards associated with the one or more predefined payment methods. As noted above, in other embodiments these data can alternatively be obtained from a payment method purveyor (316) or payment mode processor.

At step 503, these modes of payment associated with rewards, cash back, loyalty points, or other benefits can be prioritized from the most beneficial to the user of the electronic device to the least beneficial to the user of the electronic device. Thus, if paying with an electronic wallet debit card nets five percent cash back while paying with a physical credit card nets only one percent, the electronic wallet debit card can be prioritized above the physical credit card at step 503, all else being equal.

Turning now back to FIG. 3, at step 305 the method 300 presents, by one or more processors of an electronic device on a user interface of the electronic device, the one or more payment modes offered by the merchant in an offered payment mode notification. In one or more embodiments, step 305 comprises presenting, by one or more processors on a user interface of an electronic device, an offered payment mode notification identifying a preferred payment mode and, where also determined, one or more of a maximum discount and/or maximum loyalty program reward. In one or more embodiments, this step 305 occurs prior to the expected future financial transaction predicted by decision 302 and decision 303 occurs.

In one or more embodiments, the offered payment mode notification presented at step 305 comprises a reminder 313 to take a physical payment mode along when heading to the merchant to engage in the financial transaction corresponding to the expected future financial transaction. In other embodiments, the offered payment mode notification presented at step 305 comprises a reminder 314 to add a particular payment mode to an electronic wallet operating on one or more processors of the electronic device.

Embodiments of the disclosure contemplate that it can be advantageous to deliver the offered payment mode notification at predefined times. Accordingly, in one or more embodiments step 305 comprises presenting the offered payment mode notification at a predetermined time during the day. Examples of such predetermined times of day including the start of the day or when a user leaves home.

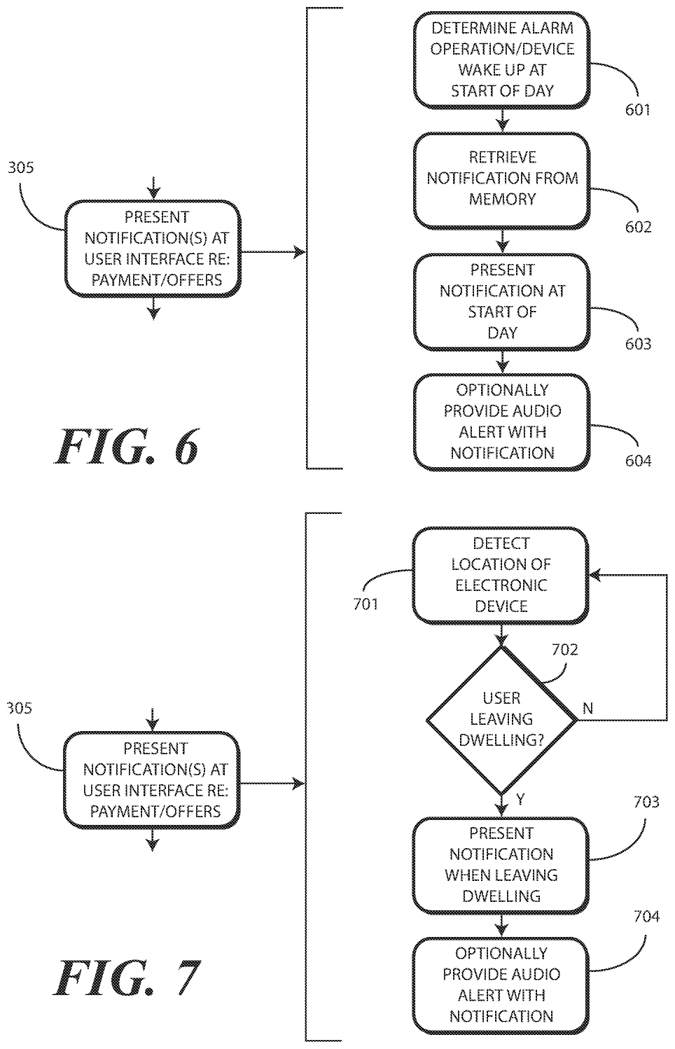

Turning briefly to FIG. 6, illustrated therein are one or more method steps indicating how an offered payment mode notification can be presented at step 305 and a predetermined time of day. In one or more embodiments the predetermined time corresponds with actuation of an alarm using an alarm application operating on one or more processors of an electronic device. Accordingly, step 601 can detect one or more of the actuation of the alarm, a user waking up, or the start of the day. Step 602 can retrieve a previously generated offered payment mode notification from memory. Step 603 can present the offered payment mode notification at the start of the day. Optional step 604 can deliver, with an audio output device by one or more processors of the electronic device, an audible alert concurrently with the presentation of the offered payment mode notification.

As an alternative to the start of the day, in other embodiments step 305 can comprise presenting the offered payment mode notification when a user leaves their dwelling. Turning now to FIG. 7, illustrated therein are one or more method steps illustrating how this can occur.

Beginning at step 701, in one or more embodiments a local display of the electronic device determines a location of the electronic device. At decision 702, the local display determines whether the electronic device is exiting the dwelling of an authorized user of the electronic device. Where it is, in one or more embodiments step 305 comprises presenting, at step 703, the offered payment mode notification when the electronic device exits the dwelling of the authorized user of the electronic device. Optional step 704 can deliver, with an audio output device by one or more processors of the electronic device, an audible alert concurrently with the presentation of the offered payment mode notification.

Turning now back to FIG. 3, at step 306 the method can repeat each time a new prospective financial transaction or expected future financial transaction is detected. As illustrated and described the method 300 of FIG. 3 predicts one or more prospective financial transaction or expected future financial transactions and gathers payment modes offered by a merchant. The method 300 optionally prioritizes the payment modes by maximum discount and/or maximum loyalty program reward and presents an offered payment mode notification listing optimal payment modes on a user interface of the electronic device. This offered payment mode notification can be presented at the right time, examples of which include the start of the day or when a user leaves home. Advantageously, situations like than plaguing poor Krish (907) in FIG. 9 can be avoided using embodiments of the disclosure.

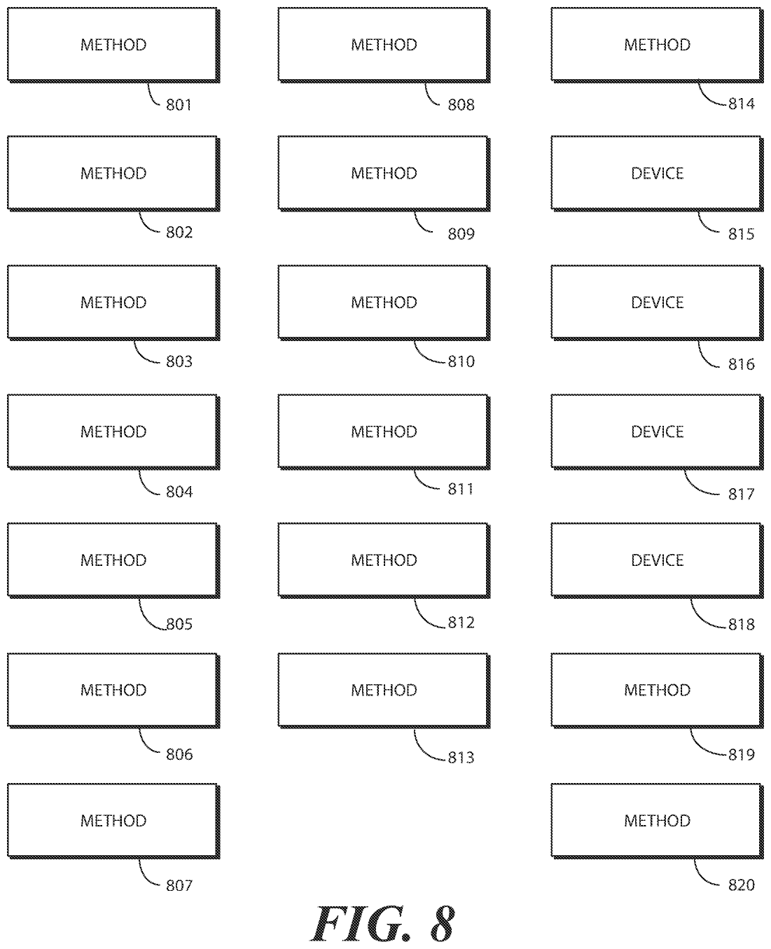

Turning now to FIG. 8, illustrated therein are various embodiments of the disclosure. The embodiments of FIG. 8 are shown as labeled boxes in FIG. 8 due to the fact that the individual components of these embodiments have been illustrated in detail in FIGS. 1-7, which precede FIG. 8. Accordingly, since these items have previously been illustrated and described, their repeated illustration is no longer essential for a proper understanding of these embodiments. Thus, the embodiments are shown as labeled boxes.

At 801, a method in an electronic device comprises detecting, with one or more processors of the electronic device, a prospective financial transaction with a merchant. At 801, the method comprises retrieving, with a communication device of the electronic device, one or more payment modes offered by the merchant from a remote electronic device across a network.

At 801, the method comprises presenting, by the one or more processors on a user interface of the electronic device, the one or more payment modes offered by the merchant in an offered payment mode notification. At 802, the prospective financial transaction of 801 with the merchant requires payment on site at the merchant.

At 803, the detection of the prospective financial transaction with the merchant of 802 comprises querying, by the one or more processors, a calendaring application to detect a scheduled appointment stored in the calendaring application that identifies the merchant. At 804, the detection of the prospective financial transaction with the merchant of 802 comprises receiving, with the communication device by the one or more processors, an electronic communication identifying both a scheduled appointment and the merchant.

At 805, the detection of the prospective financial transaction with the merchant of 802 comprises querying, from a memory of the electronic device by the one or more processors, past financial transactions made by an authorized user of the electronic device that are stored in the memory, determining, by the one or more processors, a repeating pattern of one or more repeating financial transactions, and predicting, by the one or more processors, another instance of the repeating pattern as the prospective financial transaction. At 806, the detection of the prospective financial transaction with the merchant of 802 comprises querying, by the one or more processors from a memory of the electronic device, an electronically stored to-do list to identify one or more to-do items stored in the memory that reference the merchant.

At 807, the detection of the prospective financial transaction with the merchant of 802 comprises querying, by the one or more processors from a memory of the electronic device, an Internet search history of a web browsing application stored in the memory to identify a search history entry identifying the merchant. At 808, the retrieving the one or more payment modes offered by the merchant form the remote electronic device across the network at 802 comprises extracting, by the one or more processors using the communication device, data from a merchant website provided by the merchant. At 809, the data of 808 comprises one or more of discounts offered by the merchant using one or more predefined payment methods accepted by the merchant and/or one or more loyalty programs offering one or more rewards associated with the one or more predefined payment methods.

At 810, the retrieving the one or more payment modes offered by the merchant form the remote electronic device across the network at 802 comprises extracting, by the one or more processors using the communication device, data from a payment method purveyor or payment mode processor. At 811, the presenting the one or more payment modes offered by the merchant in the offered payment mode notification of 802 occurs at a predetermined time during the day.

At 812, the predetermined time of 811 corresponds with actuation, by the one or more processors, of an alarm using an alarm application operating on the one or more processors. At 813, the method of 811 further comprises detecting, by a location detector, the electronic device exiting a dwelling of an authorized user of the electronic device. At 813, the predetermined time during the day occurs when the electronic device exits the dwelling of the authorized user of the electronic device. At 814, the method of 813 further comprises delivering, with an audio output device by the one or more processors, an audible alert concurrently with presentation of the one or more payment modes offered by the merchant in the offered payment mode notification.

At 815, an electronic device comprises a user interface, a communication device, and one or more processors operable with the user interface and communication device. At 815, the one or more processors are configured to determine a prospective financial transaction with a merchant requiring an on-site payment, retrieve, using the communication device, one or more payment modes accepted by the merchant using electronic signals across a network, and cause the user interface to present an offered payment mode notification identifying the one or more payment modes accepted by the merchant prior to the prospective financial transaction.

At 816, the one or more processors of 815 are further configured to also retrieve, using the communication device and other electronic signals across the network, one or more incentive programs offered by the merchant with rewards offered based upon payment mode. At 816, the one or more payment modes accepted by the merchant are prioritized in accordance with the rewards offered based upon the payment mode.

At 817, the electronic device of 816 further comprises a location detector. At 817, the one or more processors are configured to cause the user interface to present the offered payment mode notification identifying the one or more payment modes accepted by the merchant in response to the location detector detecting the electronic device exiting a dwelling of an authorized user of the electronic device. At 818, the offered payment mode notification identifies the one or more payment modes accepted by the merchant comprises a reminder to electronically add the one or more payment modes accepted by the merchant to an electronic wallet application operating on the one or more processors.

At 819, a method in an electronic device comprises detecting, by one or more processors, an expected future financial transaction with a merchant requiring on-site payment. At 819, the method comprises retrieving, with a communication device of the electronic device, a preferred payment mode accepted by the merchant offering one or more of a maximum discount and/or a maximum loyalty program reward in addition to one or more payment modes accepted by the merchant from a remote electronic device across a network.

At 819, the method comprises presenting, by the one or more processors on a user interface of the electronic device, an offered payment mode notification identifying the preferred payment mode and the one or more of the maximum discount and/or the maximum loyalty program reward prior to the expected future financial transaction occurring. At 820, the remote electronic device of 819 is operated by a payment method purveyor or a payment mode processor and the maximum discount and/or the maximum loyalty reward are published only by the payment method purveyor or the payment mode processor. At 820, the preferred payment mode of 819 defines a recommended mode presented in addition to the one or more payment modes accepted by the merchant.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method in an electronic device, the method comprising:
detecting, with one or more processors of the electronic device, a prospective financial transaction with a merchant;
retrieving, with a communication device of the electronic device, one or more payment modes offered by the merchant from a remote electronic device across a network; and
presenting, by the one or more processors on a user interface of the electronic device, the one or more payment modes offered by the merchant in an offered payment mode notification.

2. The method of claim 1, wherein the prospective financial transaction with the merchant requires payment on site at the merchant.

3. The method of claim 2, wherein the detecting the prospective financial transaction with the merchant comprises querying, by the one or more processors, a calendaring application to detect a scheduled appointment stored in the calendaring application that identifies the merchant.

4. The method of claim 2, wherein the detecting the prospective financial transaction with the merchant comprises receiving, with the communication device by the one or more processors, an electronic communication identifying both a scheduled appointment and the merchant.

5. The method of claim 2, wherein the detecting the prospective financial transaction with the merchant comprises:
querying, from a memory of the electronic device by the one or more processors, past financial transactions made by an authorized user of the electronic device that are stored in the memory;
determining, by the one or more processors, a repeating pattern of one or more repeating financial transactions; and
predicting, by the one or more processors, another instance of the repeating pattern as the prospective financial transaction.

6. The method of claim 2, wherein the detecting the prospective financial transaction with the merchant comprises querying, by the one or more processors from a memory of the electronic device, an electronically stored to-do list to identify one or more to-do items stored in the memory that reference the merchant.

7. The method of claim 2, wherein the detecting the prospective financial transaction with the merchant comprises querying, by the one or more processors from a memory of the electronic device, an Internet search history of a web browsing application stored in the memory to identify a search history entry identifying the merchant.

8. The method of claim 2, wherein the retrieving the one or more payment modes offered by the merchant from the remote electronic device across the network comprises extracting, by the one or more processors using the communication device, data from a merchant website provided by the merchant.

9. The method of claim 8, wherein the data comprises one or more of discounts offered by the merchant using one or more predefined payment methods accepted by the merchant and/or one or more loyalty programs offering one or more rewards associated with the one or more predefined payment methods.

10. The method of claim 2, wherein the retrieving the one or more payment modes offered by the merchant from the remote electronic device across the network comprises extracting, by the one or more processors using the communication device, data from a payment method purveyor or payment mode processor.

11. The method of claim 2, wherein the presenting the one or more payment modes offered by the merchant in the offered payment mode notification occurs at a predetermined time during the day.

12. The method of claim 11, wherein the predetermined time corresponds with actuation, by the one or more processors, of an alarm using an alarm application operating on the one or more processors.

13. The method of claim 11, further comprising:
detecting, by a location detector, the electronic device exiting a dwelling of an authorized user of the electronic device;
wherein the predetermined time during the day occurs when the electronic device exits the dwelling of the authorized user of the electronic device.

14. The method of claim 13, further comprising delivering, with an audio output device by the one or more processors, an audible alert concurrently with presentation of the one or more payment modes offered by the merchant in the offered payment mode notification.

15. An electronic device, comprising:
a user interface;
a communication device; and
one or more processors operable with the user interface and communication device;
wherein the one or more processors are configured to determine a prospective financial transaction with a merchant requiring an on-site payment, retrieve, using the communication device, one or more payment modes accepted by the merchant using electronic signals across a network, and cause the user interface to present an offered payment mode notification identifying the one or more payment modes accepted by the merchant prior to the prospective financial transaction.

16. The electronic device of claim 15, wherein the one or more processors are further configured to also retrieve, using the communication device and other electronic signals across the network, one or more incentive programs offered by the merchant with rewards offered based upon a payment mode, wherein the one or more payment modes accepted by the merchant are prioritized in accordance with the rewards offered based upon the payment mode.

17. The electronic device of claim 16, further comprising a location detector, wherein the one or more processors are configured to cause the user interface to present the offered payment mode notification identifying the one or more payment modes accepted by the merchant in response to the location detector detecting the electronic device exiting a dwelling of an authorized user of the electronic device.

18. The electronic device of claim 17, wherein the offered payment mode notification identifying the one or more payment modes accepted by the merchant comprises a reminder to electronically add the one or more payment modes accepted by the merchant to an electronic wallet application operating on the one or more processors.

19. A method in an electronic device, the method comprising:
detecting, by one or more processors, an expected future financial transaction with a merchant requiring on-site payment;
retrieving, with a communication device of the electronic device, a preferred payment mode accepted by the merchant offering one or more of a maximum discount and/or a maximum loyalty program reward in addition to one or more payment modes accepted by the merchant from a remote electronic device across a network; and
presenting, by the one or more processors on a user interface of the electronic device, an offered payment mode notification identifying the preferred payment mode and the one or more of the maximum discount and/or the maximum loyalty program reward prior to the expected future financial transaction occurring.

20. The method of claim 19, wherein:
the remote electronic device is operated by a payment method purveyor or a payment mode processor and the maximum discount and/or the maximum loyalty reward are published only by the payment method purveyor or the payment mode processor; and
the preferred payment mode defines a recommended mode presented in addition to the one or more payment modes accepted by the merchant.
